(19) United States
(12) Patent Application Publication
(10) Pub. No.: US 2020/0255615 A1
(43) Pub. Date: Aug. 13, 2020

(54) GAS BARRIER FILM AND PACKAGING MATERIAL

(71) Applicants: TOPPAN PRINTING CO., LTD., Tokyo (JP); TOPPAN USA, INC., Griffin, GA (US)

(72) Inventors: Tomokazu MURASE, Tokyo (JP); Rebecca HARMAN, Griffin, GA (US); Miki FUKUGAMI, Tokyo (JP)

(73) Assignees: TOPPAN PRINTING CO., LTD., Tokyo (JP); TOPPAN USA, INC., Griffin, GA (US)

(21) Appl. No.: 16/861,362

(22) Filed: Apr. 29, 2020

Related U.S. Application Data
(63) Continuation of application No. PCT/JP2018/040894, filed on Nov. 2, 2018.

(30) Foreign Application Priority Data
Nov. 2, 2017 (US) 15801382

(51) Int. Cl. C08J 7/048; C08K 3/34; B32B 7/12; B32B 27/30; B32B 27/24

(52) U.S. Cl. CPC C08J 7/048; C08K 3/34; B32B 7/12; B32B 27/306; B32B 27/24; C08J 2300/14; C08K 2201/003; C08J 2429/04; B32B 2439/00; B32B 2307/31; B32B 2307/7244; C08K 2201/009

(57) ABSTRACT

A gas barrier film includes a first base material film made of a plastic material and a coating layer formed on one of surfaces of the first base material film, the coating layer contains a watersoluble polymer and a water-swelling mica, the solid content ratios of the water-swelling mica in 5 a total solid content of the coating layer are within approximate ranges indicated from 20 mass % to 50 mass %, the mean area diameter of the water-swelling mica is within approximate ranges indicated from 0.5 μm to 5 μm, and the thickness of the coating layer is within approximate ranges indicated from 0.1 μm to 1 μm.

### CROSS-REFERENCE TO RELATED PATENT APPLICATIONS

This application is a Bypass Continuation Application of International Patent Application No. PCT/JP2018/040894, filed on Sep. 5, 2019, which is based upon and claims the benefit of priority to U.S. patent application Ser. No. 15/801,382, filed on Nov. 2, 2017; the disclosures of which are all incorporated herein by reference in their entireties.

### TECHNICAL FIELD

This invention relates to a gas barrier film to limit moisture and/or oxygen that can be used a packaging material. The packaging material to package foods, such as dried foods, confectionaries, breads and pastries, delicacies and the like, or also for medical goods such as tablets, powders, poultices, adhesive skin patches and the like. (Of course, other materials can be packaged.) Particularly, the invention relates to a gas barrier film used in packaging fields for applications requiring high gas barrier properties and also having a transparency to still enable visual recognition of the contents. Also, this invention relates to packaging materials comprising the new gas barrier film.

### BACKGROUND ART

Packaging materials used for foods and medical goods should include properties (e.g., gas barrier properties) that slow or even stop the permeation of water vapor, oxygen and other gases capable of causing content quality to be deteriorated. Such properties will suppress the contents from being deteriorated or decayed and to aid in retaining the function and properties of foods and medical goods.

Therefore, packaging materials have been provided thus far to include a gas barrier layer made of a material having gas barrier properties. Until now, the gas barrier layer has been formed on a base material such as a film or paper according to a sputtering or vacuum deposition method, or a wet coating or printing method. The gas barrier layer used thus far can include a metal foil or metal deposition film made of a metal such as aluminum, or a resin film such as of polyvinyl alcohol, an ethylene/vinyl alcohol copolymer, polyvinylidene chloride or the like.

In order to improve the gas barrier properties of these resin films, there has been proposed composite resin films of resins and inorganic layered minerals. For example, these proposed composite resin films have been described, for example, in U.S. Pat. No. 5,700,560 (Patent Literature 1) and U.S. Pat. No. 5,981,029 (Patent Literature 2) With these types of composite resin films, it is necessary that an inorganic layered mineral be distributed and arranged in order in the inside of the film so as to allow improved gas barrier properties. However, as the inorganic layered mineral is distributed and arranged in order, the cohesive force of the resin film and the adhesion force of the film to a base material can become lower. Thus, it is very difficult to satisfy both the high gas barrier properties and the adhesion strength sufficient for use as a packaging material.

### CITATION LIST

### Patent Literature

[PTL 1] U.S. Pat. No. 5,700,560
[PTL 2] U.S. Pat. No. 5,981,029

### SUMMARY OF INVENTION

### Technical Problem

The present invention has been made under such circumstances of the prior art as stated above and has for an object the provision of a gas barrier film that has both improved gas barrier properties and has adhesion strength and cohesive strength of a resin film sufficient for use as a packaging material. Also, the invention has for an object the provision of a packaging material that has improved gas barrier properties and sufficient laminate strength.

### Solution to Problem

A gas barrier film to a first embodiment of the invention comprises a first base material film made of a plastic material and a coating layer formed on one of surfaces of the first base material film, wherein the coating layer contains a water-soluble polymer and a water-swelling mica, the solid content ratios of the water-swelling mica in a total solid content of the coating layer being within approximate ranges indicated from 20 mass % to 50 mass %, the mean area diameter of the water-swelling mica being within approximate ranges indicated from 0.5 μm to 5 μm, and the thickness of the coating layer being within approximate ranges indicated from 0.1 μm to 1 μm.

In the first embodiment of the invention, the water-soluble polymer may be polyvinyl alcohol resin and the degree of polymerization of the polyvinyl alcohol resin may be within approximate ranges indicated from 1,100 to 2,300.

In the first embodiment of the invention, the aspect ratio of the water-swelling mica may be within approximate ranges indicated from 10 to 200.

In the first embodiment of the invention, the mean area diameter of the water-swelling mica may be within approximate ranges indicated from 1.5 μm to 2.5 μm and the thickness of the coating layer may be within approximate ranges indicated from 0.15 μm to 0.7 μm.

A gas barrier film to the first embodiment of the invention comprises a base material film made of a plastic material and a coating layer formed on one of surfaces of the first base material film. The components and thickness of the coating layer are controlled within given ranges, so that there can be obtained a gas barrier film that has both improved gas barrier properties and has adhesion strength and cohesive strength of a resin film sufficient for use as a packaging material.

A packaging material to a second embodiment of the invention comprises a first film, a second film and an adhesive layer formed between the first film and the second film, wherein the first film comprises a first base material film made of a plastic material and a coating layer formed between the first base material film and the adhesive layer, the second film comprises a second base material film made of a plastic material, the coating layer comprises a water-soluble polymer and a water-swelling mica, the solid content ratios of the water-swelling mica in a total solid content of the coating layer being within approximate ranges indicated from 20 mass % to 50 mass %, the mean area diameter of the water-swelling mica being within approximate ranges indicated from 0.5 μm to 5 μm, and the thickness of the coating layer being within approximate ranges indicated from 0.1 μm to 1 μm.

In a second embodiment of the invention, the second film may further comprise an ink layer formed between the second base material film and the adhesive layer.

In the second embodiment of the invention, the first film may further comprise an ink layer formed between the coating layer and the adhesive layer.

In the second embodiment of the invention, the first base material film and the second base material film may be made of a same plastic material.

In the second embodiment of the invention, the water-soluble polymer may be polyvinyl alcohol resin and the degree of polymerization of the polyvinyl alcohol resin may be within approximate ranges indicated from 1,100 to 2,300.

In the second embodiment of the invention, the aspect ratio of the water-swelling mica may be within approximate ranges indicated from 10 to 200.

In the second embodiment of the invention, the mean area diameter of the waterswelling mica may be within approximate ranges indicated from 1.5 μm to 2.5 μm and the thickness of the coating layer may be within approximate ranges indicated from 0.15 μm to 0.7 μm.

A packaging material made of this second embodiment of the invention comprises two films and an adhesive layer formed between the two films. One of the two film is the gas barrier film, the other film comprises a base material film made of a plastic material. The components and thickness of the coating layer of the gas barrier film are controlled within given ranges, so that there can be obtained a gas barrier film that has improved gas barrier properties and sufficient laminate strength.

### Advantageous Effects of Invention

The present invention provides a gas barrier film that has improved gas barrier properties and has both of adhesion strength and cohesive strength of a resin film sufficient for use as a packaging material. Also, the present invention provides a packaging material that has improved gas barrier properties and sufficient laminate strength.

### BRIEF DESCRIPTION OF DRAWINGS

FIG. 1 is a cross sectional view illustrating a structure of a gas barrier film exemplified in an embodiment of the invention.

FIG. 2 is a cross sectional view illustrating another structure of a gas barrier film exemplified in an embodiment of the invention.

FIG. 3 is a cross sectional view illustrating a structure of a packaging material exemplified in an embodiment of the invention.

FIG. 4 is a cross sectional view illustrating another structure of a packaging material exemplified in an embodiment of the invention.

FIG. 5 is a cross sectional view illustrating another structure of a packaging material exemplified in an embodiment of the invention.

FIG. 6A is a cross sectional view illustrating another structure of a packaging material exemplified in an embodiment of the invention. FIG. 6B is a cross sectional view illustrating another structure of a packaging material exemplified in an embodiment of the invention.

FIG. 7 is a cross sectional view illustrating a structure of a base material film exemplified in an embodiment of the invention.

FIG. 8 is a cross sectional view illustrating another structure of a base material film exemplified in an embodiment of the invention.

### DESCRIPTION OF EMBODIMENTS

Representative embodiments of the present invention are set forth, below. It is to be understood that the present invention is not necessarily limited to the following embodiments. These embodiments are illustrative and one of skill in the art could understand how to modify the representative embodiments for practicing the present invention in ways other than described, below.

(Gas Barrier Film)

The gas barrier film of a first embodiment of the invention comprises at least a base material film made of a plastic material and a coating layer formed on one of surfaces of the first base material film.

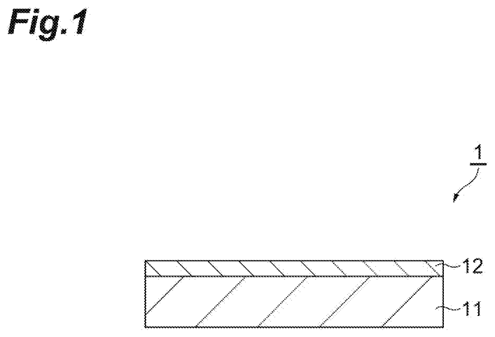

FIG. 1 is a cross sectional view illustrating a structure of a gas barrier film exemplified in an embodiment of the invention. As shown in FIG. 1, there is provided a gas barrier film 1 which includes a first base material film 11 made of a plastic material and a coating layer 12 formed on one of surfaces of the first base material film 11.

The gas barrier film of the embodiment of the invention may have, if necessary, an anchor coat layer formed between the base material film and the coating layer, an overcoat layer formed on the surface of the coating layer, or a heat seal layer or a cold seal layer formed on one or both of surfaces of the gas barrier film. The cold seal layer is formed by a material such as adhesives capable of pressure bonding at lower temperatures.

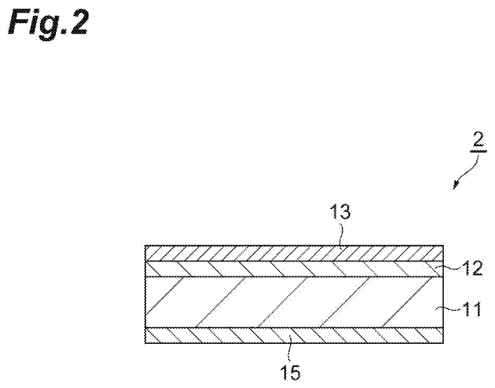

FIG. 2 is a cross sectional view illustrating another structure of a gas barrier film exemplified in an embodiment of the invention. As shown in FIG. 2, a gas barrier film 2 includes a first base material film 11 made of a plastic material, a coating layer 12 formed on one surface of the first base material film 11, an ink layer 13 formed on the a surface of the coating layer 12 and a heat seal layer 15 formed on the other surface of the first base material film 11. A cold seal layer may be formed instead of the heat seal layer 15.

(Packaging Material)

The packaging material of the embodiment of the invention comprises at least two films and an adhesive layer formed between the two films. One of the two films is the gas barrier film and the other film comprises a base material film made of a plastic material.

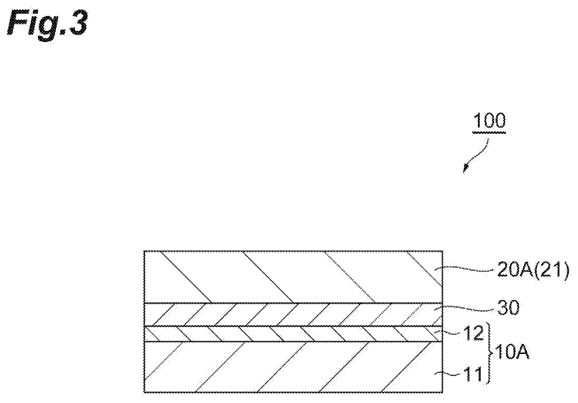

FIG. 3 is a cross sectional view illustrating a structure of a packaging material exemplified in an embodiment of the invention. As shown in FIG. 3, there is provided a packaging material 100 which includes a first film 10A, a second film 20A and an adhesive layer 30 formed between the first film 10A and the second film 20A. There is provided the first film 10A which is a gas barrier film and includes a first base material film 11 made of a plastic material and a coating layer 12 formed between the first base material film 11 and the adhesive layer 30, there is provided the second film 20A which includes a second base material film 21 made of a plastic material.

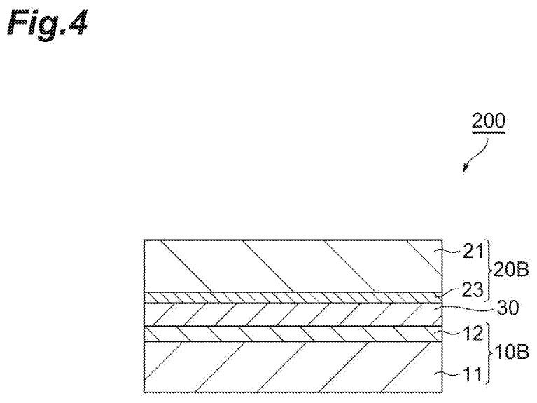

FIG. 4 is a cross sectional view illustrating another structure of a packaging material exemplified in an embodiment of the invention. As shown in FIG. 4, there is provided a packaging material 200 which includes a first film 10B, a second film 20B and an adhesive layer 30 formed between the first film 10B and the second film 20B. There is provided the first film 10B which is a gas barrier film and includes a first base material film 11 made of a plastic material and a coating layer 12 formed between the first base material film 11 and the adhesive layer 30. There is provided the second film 20B which includes a second base material film 21 made of a plastic material and an ink layer 23 formed between the second base material film 21 and the adhesive layer 30.

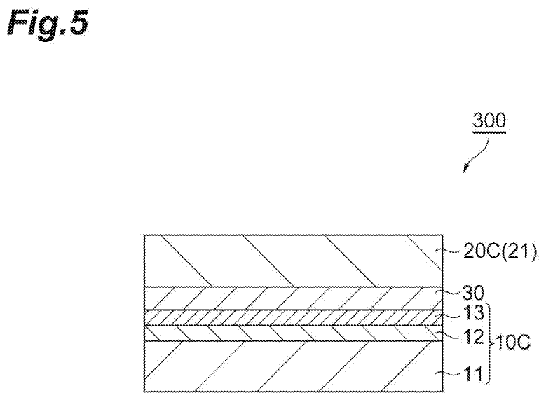

FIG. 5 is a cross sectional view illustrating another structure of a packaging material exemplified in an embodiment of the invention. As shown in FIG. 5, there is provided a packaging material 300 which includes a first film 10C, a second film 20C and an adhesive layer 30 formed between the first film 10C and the second film 20C. There is provided the first film 10C which is a gas barrier film and includes a first base material film 11 made of a plastic material, a coating layer 12 formed on one of surfaces of the first base material film 11, and an ink layer 13 formed between the coating layer 12 and the adhesive layer 30. There is provided the second film 20C which includes a second base material film 21 made of a plastic material.

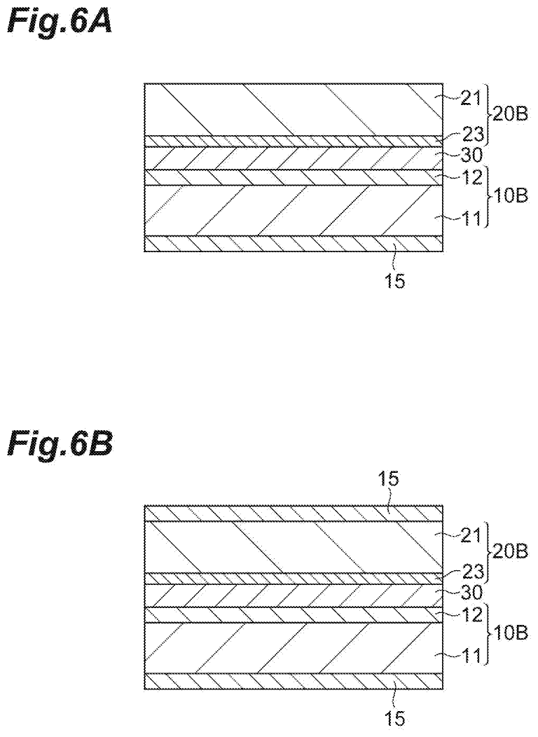

The packaging material of the embodiment of the invention may have, if necessary, a heat seal layer 15 formed on one or both of surfaces of the packaging material as shown FIG. 6A and FIG. 6B. The packaging material may have a cold seal layer instead of the heat seal layer.

(Base Material Film)

The base material film is made of a plastic material. For the base material film made of a plastic material, mention is made, for example, of those films of polyolefin resins such as polyethylene, polypropylene, propylene-ethylene copolymers and the like, polyester resins such as polyethylene terephthalate, polybutylene terephthalate and the like, aliphatic polyamides such as nylon 6 and nylon 66, polyamide resins including aromatic polyamides such as polymethaxylylene adipamide and the like, vinyl resins such as polystyrene, polyvinyl acetate, ethylene-vinyl acetate copolymer, polyvinyl alcohol, ethylene-vinyl alcohol copolymer and the like, acrylic resins including homopolymers or copolymers of (meth)acrylic monomers such as polymethyl methacrylate, polyacrylonitrile and the like, and cellophane. These resins may be used singly or in combination of two or more.

Of these, preferred base material films include polyolefin resin films (specifically, a polypropylene film), polyester resin films (specifically, a polyethylene terephthalate resin film), and polyamide films (specifically, nylon films).

For the base material film, there is used a single-layer film constituted of a single resin, or a single-layer film or laminate film making use of a plurality of resins. Alternatively, laminate base materials of the type wherein these resins are laminated on other types of base materials (such as metals, wood pieces, paper, ceramics and the like) may be used.

The base material film may be either an unstretched film, or a uniaxially stretched film or biaxially stretched film. Those films subjected to a surface treatment (corona discharge treatment), anchor coating, or an undercoating treatment may also be used.

When the base material film is subjected to a corona treatment, low temperature plasma treatment, atmospheric pressure plasma or the like on a surface to be coated (i.e. a surface on which a film is formed), good wettability to a coating agent and good adhesion to film are ensured.

The thickness of the base material film is not critical and may be appropriately selected depending on the cost and purpose in use while taking fitness for packaging material and lamination aptitude of other type of film into account. The thickness of the base material film is in practice at 3 μm to 200 μm, preferably at 5 μm to 120 μm and more preferably at 10 μm to 100 μm.

Among the two base material films (the first base material film and the second base material film) which are used for the packaging material, the second base material film may be a base material film having heat sealing properties. For the base material film having heat sealing properties, mention is made, for example of unstretched polyethylene films or unstretched polypropylene films.

The two base material films (the first base material film and the second base material film) which are used for the packaging material are preferably made of a same plastic material. The same plastic material means that the plastic materials of the main components constituting the two base material films are the same, and other components may be contained. In the case where the two films are the same plastic material, the packaging material can be torn linearly. In other words, when the packaging material is formed in a bag shape, the bag can be easily opened. In addition, since the shrinkage rates of the two base material films become substantially equal, it is possible to suppress the cohesion strength of the coating layer and the adhesion strength of the coating layer to the base material from decreasing due to external force as time passes. The two base material films are preferably polyolefin resin films (specifically, a polypropylene film), polyester resin films (specifically, a polyethylene terephthalate resin film, and the like. Especially, both of the two base material films are more preferably biaxially stretched films.

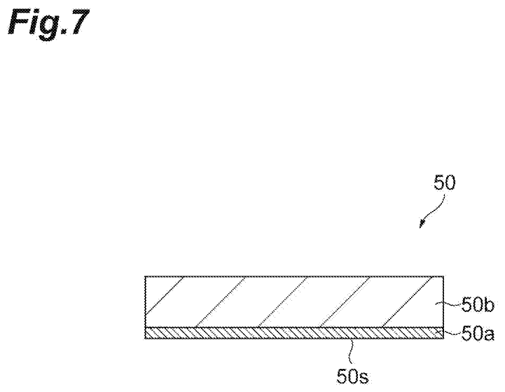

The base material film itself may have heat sealing properties so that one or both of the outermost surfaces of the packaging material have heat sealing properties. This makes it possible to produce a packaging material without bonding a sealant film to the base material film or providing a sealant layer on the base material film. FIG. 7 is a cross sectional view illustrating an example of a base material film which has heat sealing properties. The base material film 50 shown FIG. 7 includes a first layer 50a that constitutes the heat sealing surface 50s and a second layer 50b made of biaxially stretched polypropylene, and is formed as a multilayer structure in which the first layer 50a and the second layer 50b are laminated to be in contact with each other directly.

A tear strength of the base material film 50 measured by the Elmendorf method is preferably in the range of 10 mN to 100 mN, and more preferably in the range of 20 mN to 60 mN. The tear strength of the base material film 50 of 10 mN or more can facilitate preventing the packaging material from tearing unintendedly. On the other hand, with the tear strength of 100 mN or less, the packaging material has a good tear propagation and provides a refreshing experience to a user opening it. The “tear strength” refers to a value measured by the Elmendorf method in compliance with JIS K-7128 unless otherwise specified.

The first layer 50a is for imparting heat seal characteristics to the base material film 50. The melting point of the resin that constitutes the first layer 50a may be, for example, in the range of 60° C. to 140° C., or alternatively, in the range of 80° C. to 120° C. The melting point (melting temperature) of the resin can be obtained by measuring the melting point under the conditions of 30° C. to 180° C. with the temperature rising rate of 10° C./min. by using a differential scanning calorimeter in compliance with the method specified in JIS K7121:2012. The thickness of the first layer 50a is preferably in the range of 0.5 μm to 5 μm. A heat seal strength of the first layer 50a may be made to an optimal range by adjusting the thickness of the first layer 50a. When the thickness of the first layer 50a is 0.5 μm or more, heat sealing effects can be readily produced whereas when the thickness of the first layer 50a is 5 μm or less, the effect on the mechanical properties of the base material film 50 can be sufficiently reduced.

The resin material that constitutes the first layer 50a is preferably an olefin-based copolymer, and specifically a propylene copolymer in view of adhesiveness to the second layer 50b made of polypropylene. That is, the resin material may be a random copolymer in which olefin such as propylene as a main monomer and a small amount of comonomer, which differs from the main monomer, are randomly copolymerized to form a homogeneous phase, or a block copolymer in which olefin such as propylene as a main monomer and the above comonomer are present as a block copolymer or rubbery polymer to form a heterogeneous phase. Specific examples of these copolymers include a (propylene-1-butene)-(propylene-1-butene) copolymer, a (propylene-1-butene)-(propylene-ethylene-1-butene) copolymer, a (propylene-ethylene-1-butene)-(propylene-1-butene) copolymer, a (propylene-ethylene-1-butene)-(propylene-ethylene-1-butene) copolymer, or (propylene-1-hexene)-(propylene-1-hexene) copolymer, and is preferably a (propylene-1-butene)-(propylene-1-butene) copolymer, or a (propylene-1-hexene)-(propylene-1-hexene) copolymer. When an olefin-based copolymer other than propylene copolymers is used as the first layer 50a, a layer made of a propylene copolymer may be provided as an intermediate layer to improve adhesiveness between the first layer 50a and the second layer 50b.

The second layer 50b is made of polypropylene. The tear strength of the second layer 50b measured by the Elmendorf method is preferably in the range of 10 mN to 100 mN, and more preferably in the range of 20 mN to 60 mN. When the second layer 50b is formed of a biaxially stretched film, the tear strength in a vertical direction (MD) and that of a lateral direction (TD) are preferably within the above range. The thickness of the second layer 50b is not specifically limited, and for example it may be in the range of 2 μm to 200 μm, or in the range of 10 μm to 100 μm, or alternatively, in the range of 15 μm to 50 μm. This thickness can be adjusted depending on the usage or required characteristics.

The second layer 50b may contain an anti-blocking agent. An average particle diameter of the anti-blocking agent may be, for example, 1.0 μm to 5.0 μm, or 1.5 μm to 4.5 μm, or alternatively, 2.0 μm to 4.0 μm. The average particle diameter of the anti-blocking agent of 1.0 μm or more allows unevenness to be formed on the surface of the second layer 50b, facilitating a preferred anti-blocking characteristics to be obtained. Meanwhile, with the average particle diameter of the anti-blocking agent of less than 5.0 μm, an excessive unevenness on the second layer 50b can be prevented, which then prevents the second layer 50b or the coating layer from suffering scratches. The average particle diameter here is a value measured by a Coulter Counter.

The anti-blocking agent may be an inorganic or organic agent. Examples of the inorganic anti-blocking agent are calcium carbonate, calcium nitrate, barium sulfate, calcium phosphate, silica, clay, talc, or mica, and examples of the organic anti-blocking agent are polymethyl methacrylate (PMMA), polymethylsilsesquioxane (silicone), polyamide, polytetrafluoroethylene, epoxy resin, polyester resin, benzoguanamine formaldehyde (urea resin), or phenol resin. These can be used singly or in combination.

In consideration of the dispersibility of the anti-blocking agent, the transparency of the base material, the anti-blocking characteristics, and the adhesiveness between the base material film and the coating layer, the anti-blocking agent is preferably an inorganic agent, more preferably a silica, and furthermore preferably a synthetic silica. Synthetic silica shows affinity toward the coating layer in which water is used as a solvent. Synthetic silica particles provided on the coating layer side surface of the base material film can improve the adhesiveness of the base material film with the coating layer. Silica here contains in the crystalline structure a silicon dioxide of 40 mass % or more, and preferably a silicon dioxide of 50 to 10 mass %. Specifically, as an element other than silicon, silica may contain a component such as magnesium, calcium, or aluminum in the form of magnesium silicate, aluminum silicate, or calcium aluminum silicate.

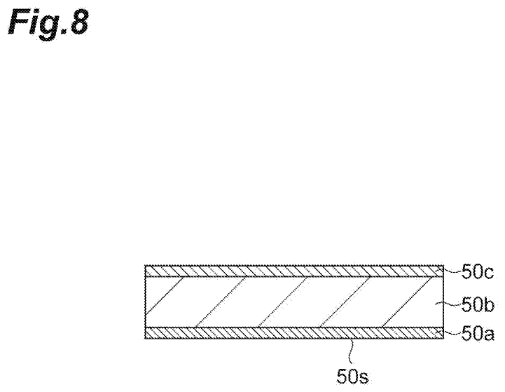

As described above, the second layer 50b of the base material film 50 may contain an anti-blocking agent. The coating layer side surface of the base material film 50 may be provided with a skin layer 50c containing the anti-blocking agent (see FIG. 8). In this case, the second layer 50b may or may not include the anti-blocking agent.

The base material film 50 can be obtained by laminating the first layer 50a and the second layer 50b by a known resin lamination method such as extrusion lamination, co-extrusion, or inflation, and then stretching the layers in the vertical direction (MD) and the lateral direction (TD) concurrently or subsequently. The base material film 50 can be used as the first base material film 11 and/or the second base material film 21 of the above embodiment.

(Coating Layer)

The coating layer of the embodiment of the invention contains at least a water-soluble polymer and one or more water-swelling micas.

(Water-Soluble Polymer)

The water-soluble polymer means one that is completely dissolved in or finely dispersed in water at a specific temperature. The water-soluble polymer is not specifically limited so far as it is able to permit interstitial invasion or intercalation between unit crystal layers of an inorganic layered mineral described hereinafter. For example, mention is made of polyvinyl alcohol and derivatives thereof, cellulose derivatives such as carboxymethyl cellulose, hydroxyethyl cellulose and the like, starches such as oxidized starch, etherized starch, dextrin and the like, polyvinylpyrrolidone, polyacrylic acid and polymethacrylic acid or esters, salts and copolymers thereof, copolymerized polyesters containing a polar group such as sulfoisophthalic acid, vinyl polymers such as polyhydroxyethyl methacrylate and copolymers thereof, urethane polymers, or a variety of the above-indicated polymers whose functional group, such as a carboxyl group, is modified.

The water-soluble polymer is preferably a polyvinyl alcohol resin whose degree of saponification is 95% or higher. With polyvinyl alcohol resin, higher degrees of saponification and polymerization tend to have lower hygroscopicity and swellability. In the case where the degree of saponification is 95% or higher, adequate gas barrier properties are likely to be obtained.

When the water-soluble polymer is a polyvinyl alcohol resin, the polyvinyl alcohol resin may contain, as at least one component, a polyvinyl alcohol polymer and its derivative.

A degree of polymerization of the polyvinyl alcohol resin is preferably at 1,100 to 2,300, and more preferably at 1,500 to 2,000. If the degree of polymerization of polyvinyl alcohol resin is within the above range, there can be obtained a film whose gas barrier properties and cohesive strength of the coating layer are improved. Especially, in the case where the degree of polymerization of polyvinyl alcohol resin is 1,100 or higher, preferably 1,500 or higher, there can be obtained a film whose gas barrier properties is further improved.

(Water-Swelling Micas)

The mica or micas mean a kind of an inorganic layered mineral wherein very thin unit crystal layers are superposed to form one layered particle. The micas include natural mica and synthetic mica. For example, mention is made of muscovite, phlogopite, biotite, potassium phlogopite, potassium tetrasilicic mica, sodium taeniolite, potassium fluortetrasilicic mica, sodium fluortetrasilicic mica, sodium phlogopite, sodium tetrasilicic mica, sodium hectorite, and the like. For purposes of this invention, one mica could be used or two or more different micas could be combined together.

For the micas, those that are able to be swelled and cleft in water are preferred. Among them, water-swelling micas having swellability in water are preferably used. More specifically, the synthetic micas are one which enables water to be intercalated between very thin unit crystal layers and thus, has properties of absorption and swelling, and is generally a compound wherein a layer of a tetrahedral structure formed by coordination of Si⁴⁺ with O²⁻ and a layer of an octahedral structure formed by coordination of Al³⁺, Mg²⁺, Fe²⁺, Fe³⁺ or the like with O²⁻ and OH⁻ are bonded at a ratio of 1:1 or 2:1 and superposed to form a layered structure. For example, the sodium fluortetrasilicic mica is preferred.

From the standpoint that a high aspect ratio leads to improved barrier properties of film, preferably 10 to 200 and more preferably 50 to 150. If the aspect ratio of the water-swelling mica is within the above range, there is an increased chance that a film can be obtained whose gas barrier properties are improved, and at the same time it is possible to suppress decrease in the adhesion strength of the coating layer to a base material film and the cohesive strength of the coating layer.

Also, mean area diameter (MA) of the water-swelling mica is preferably at 0.5 μm to 5 μm, more preferably at 1 μm to 3 μm, and much more preferably at 1.5 μm to 2.5 μm. The mean area diameter is an average particle diameter weighted by area. If the mean area diameter of the water-swelling mica is within the above range, there can be obtained a film whose gas barrier properties and transparency are maintained or improved because the water-swelling mica is more uniformly dispersed in the coating layer without precipitation of the water-swelling mica.

When using a water-swelling synthetic mica as the water-swelling mica, the waterswelling synthetic mica is high in compatibility with the water-soluble polymer and has a reduced content of impurities over natural micas, so that gas barrier properties and cohesive strength of the coating layer are not lowered owing to the impurities. Without being limited to a specific mechanism, it is believed that because of the fluorine atom contained in the crystal structure, the water-swelling synthetic mica contributes to suppressing the humidity dependence of the gas barrier properties of the coating layer. Moreover, because of a higher aspect ratio than other types of water-swelling inorganic layered minerals, the tortuous pass works more effectively, and the water-swelling synthetic mica contributes to high development of gas barrier properties of the coating layer.

Especially in the case where the water-soluble polymer is a polyvinyl alcohol resin, the water-swelling synthetic mica has high compatibility with the polyvinyl alcohol resin. In addition, in the case where mean area diameter of the water-swelling synthetic mica is preferably at 0.5 μm to 5 μm, more preferably at μm to 3 μm and much more preferably at 1.5 μm to 2.5 μm, the water-swelling synthetic mica has higher compatibility with the polyvinyl alcohol resin.

In the case where the water-swelling synthetic mica has higher compatibility with the polyvinyl alcohol resin, the polyvinyl alcohol resin having a higher degree of polymerization can be used. When using the polyvinyl alcohol resin having a higher degree of polymerization, there can be obtained a film whose gas barrier properties is further improved. Specifically, in the case where mean area diameter of the water-swelling synthetic mica is at 0.5 μm to 5 μm, preferably at 1 μm to 3 μm and more preferably at 1.5 μm to 2.5 μm, the degree of polymerization of polyvinyl alcohol resin can be 1,100 or higher, and there can be obtained a film whose gas barrier properties is further improved.

The solid content ratio of the water-swelling mica or micas occupied in the total solid content of the coating layer is at 20 to 50 mass %. The lower limit of the ratio may be 30 mass %, 32 mass %, or 35 mass %. The upper limit of the ratio may be 45 mass %, 42 mass %, or 40 mass %. If the solid content ratio of the water-swelling mica occupied in the total solid content of the coating layer is less than 20 mass %, satisfactory gas barrier properties are not obtained with respect to the coating layer. On the other hand, when the solid content ratios of the water-swelling mica occupied in the total solid content of the coating layer exceeds 50 mass %, the adhesion strength of the coating layer to a base material film and the cohesive strength of the coating layer are both lowered as time passes. In the case where the solid content ratios are outside the given ranges and the cohesive strength of the coating layer and the adhesion strength of the coating layer to a base material film are lowered with time, a packaging material having the coating layer is degraded in laminate strength with time. For example, with the ratio of 30 to 40 mass %, the gas barrier properties can be prevented from decreasing even if a tensile strength is added to a gas barrier film in the MD (Machine Direction) in the case that the gas barrier film is produced with a roll to roll process. If the base material film is a biaxially stretched film, the oxygen permeability measured after the gas barrier film is elongated by 5% in the MD of the base material film is preferably 10 cm³/m²-day-atm or less, more preferably 8 cm³/m²-day-atm or less, and furthermore preferably 5 cm³/m²-day-atm. The water vapor permeability measured after the gas barrier film is elongated by 5% in the MD of the base material film is preferably 5 g/m²-day or less, more preferably 4 g/m²-day or less, and furthermore preferably 3 g/m²-day.

While not being limited to this mechanism, it is believed that the higher the solid content ratios of the water-swelling mica, that the more satisfactory gas barrier properties are obtained with respect to the coating layer, but both of the adhesion strength of the coating layer to a base material film and the cohesive strength of the coating layer are lowered. However, by adjusting the average particle diameter of the water-swelling mica, it is possible to further heighten the solid content ratios of the water-swelling mica. As a result, it is possible to obtain a film with improved gas barrier properties while suppressing decrease in the adhesion strength of the coating layer to a base material film and the cohesive strength of the coating layer. Specifically, in the case where the solid content ratios of the water-swelling mica occupied in the total solid content of the coating layer is at 20 to 50 mass %, mean area diameter of the waterswelling mica is preferably at 0.5 μm to 5 μm, more preferably at 1 μm to 3 μm and much more preferably at 1.5 μm to 2.5 μm.

(Method for Forming the Coating Layer)

The coating layer comprised mainly of the water-soluble polymer and the waterswelling mica is formed by coating, on a base material film, a coating agent containing at least the water-soluble polymer and the water-swelling mica as main constituents according to a known wet coating process, followed by dry removal of a solvent component.

The coating agent primarily contains water as a solvent and may also contain a solvent dissolved in or uniformly mixed with water. The solvents include, for example, alcohols such as methanol, ethanol, isopropanol and the like, ketones such as acetone, methyl ethyl ketone and the like, ethers such as tetrahydrofuran and the like, cellosolves, carbitols, and nitriles such as acetonitrile and the like.

The wet coating methods used can include those of roll coating, gravure coating, reverse coating, die coating, screen printing, spray coating and the like. Using these wet coating methods, a coating agent is coated onto one or both of surfaces of a base material film. For drying the coating agent, there are used known drying methods including such as of hot air drying, hot roll drying, IR irradiation and the like.

The thickness of the coating layer formed on the base material film is set depending on the gas barrier properties required. The thickness of the coating layer formed on the base material film is preferably at 0.1 μm to 1 μm, more preferably at 0.15 μm to 0.7 μm, much more preferably at 0.2 μm to 0.5 μm. If the coating layer thickness is less than 0.1 μm, satisfactory gas barrier properties are unlikely to be obtained. On the other hand, when the coating layer thickness exceeds 1 μm, not only a difficulty is involved in providing a uniform coating surface, but also a drying load and production costs increase, thus being unfavorable.

The thickness of the coating layer formed on the base material film can be made thinner while the coating layer maintains sufficient barrier properties by adjusting the average particle diameter of the water-swelling mica. The reason is because the water-swelling mica is more uniformly dispersed in the coating layer by adjusting the average particle diameter of the waterswelling mica. Particularly, in the case where mean area diameter of the water-swelling synthetic mica is at 0.5 μm to 5 μm, preferably at 1 μm to 3 μm and more preferably at 1.5 μm to 2.5 μm, the thickness of the coating layer can be 1 μm or lower while the coating layer maintains sufficient barrier properties.

The coating layer may further contain a variety of additives within ranges not impeding gas barrier properties and strength as a packaging material. As an additive, mention is made, for example, of antioxidants, weathering agents, thermal stabilizers, lubricants, crystal nucleating agents, UV absorbers, plasticizers, antistatic agents, colorants, fillers, surfactants, silane coupling agents and the like.

(Ink Layer)

The ink layer is formed in order to be practically used as a packing bag or the like, and is a layer formed by ink in which various pigments, such as an extender pigment, additives, such as a plasticizer, a drying agent, or a stabilizer, are added to an ink binder resin that has been used in the related art, such as a urethane-based resin, an acryl-based resin, a cellulose nitrate-based resin, a rubber-based resin, or a vinyl chloride-based resin. Character, patterns, or the like are formed on the printing layer.

(Adhesive Layer)

For adhesives used as the adhesive layer, well-known adhesives, such as an acryl-based adhesive, a polyester-based adhesive, an ethylene vinyl acetate-based adhesive, a urethane-based adhesive, a vinyl chloride vinyl acetate-based adhesive, and a chlorinated polypropylene-based adhesive, can be used according to the materials of respective layers to be laminated. As coating methods of adhesives for forming the adhesive layer, well-known coating methods can be used. For example, a roll coater, a reverse roll coater, a photogravure coater, a micro-photogravure coater, a knife coater, a bar coater, a wire bar coater, a die coater, a dip coater, or the like can be used. As the coating amount of the adhesives, 1 to 10 g/m² is preferable.

(Anchor Coat Layer)

For an anchor coating agent used as the anchor coating layer, it is preferable that the anchor coating agent is selected, for example, from solvent-soluble or water-soluble polyester resins, isocyanate resins, urethane resins, acrylic resins, vinyl alcohol resins, ethylene vinyl alcohol resins, vinyl-modified resins, epoxy resins, oxazoline group-containing resins, modified styrene resins, modified silicone resins, or alkyl titanate, or the like. These may be used singly or in combination of two or more.

(Heat Seal Layer)

The heat seal layer serves as a bonding portion at the time of forming a packaging material. Examples of constituents of the heat seal layer include resins, such as polyethylene, polypropylene, an ethylene-vinyl acetate copolymer, an ethylene-methacrylic acid copolymer, an ethylene-methacrylic acid ester copolymer, an ethylene-acrylic acid copolymer, ethylene-acrylic acid ester copolymer, and metal crosslinked products thereof. The thickness of the heat seal layer is, for example, 15 μm to 200 μm.

### EXAMPLES

Examples and Comparative Examples are described to more particularly illustrate the invention, which should not be construed as limited to the following examples.

### Examples and Comparative Examples

For water-soluble polymer, polyvinyl alcohol resin (Selvol-325 with a degree of saponification of 98 to 99% and a degree of polymerization of 1700, manufactured by Sekisui Specialty Chemicals America, LLC.) was used. The polyvinyl alcohol resin and water were mixed, heated at 95° C., and the polyvinyl alcohol resin was dissolved in water. The mixtures were cooled down to room temperature, followed by diluting with water and isopropanol (at a mass ratio of 1:1) in such a way that a final solid concentration was made at 5 mass % thereby preparing components (A).

For the water-swelling mica, water-swelling synthetic micas (Somasif MEB-3, manufactured by Co-op Chemical Co., Ltd.) was used. The water-swelling synthetic micas at mean area diameters indicated in Tables 1 were prepared by use of a bead mill, followed by mixed with water in such a way that a final solid concentration was made at 8 mass % thereby preparing components (B).

The components (A) and (B) were formulated at solid content ratios of the waterswelling micas indicated in Tables 1, followed by diluting with water and methanol (at a mass ratio of 1:1) in such a way that a final solid concentration was made at 4.5 mass % thereby preparing coating agents.

The coating agents of Examples 1 to 9 and Comparative Examples 1 to 5 were each coated, by use of a gravure coater, onto an atmospheric pressure plasma-treated surface of biaxially stretched polypropylene film (CBP with a thickness of 20 μm, manufactured by Toray Co., Ltd.) followed by drying by passage through an oven at 90° C. for 10 seconds, thereby obtaining gas barrier films of Examples 1 to 9 and Comparative Examples 1 to 5.

(Evaluation)

### (Measurement of Oxygen Permeability (Equal Pressure Method))

The oxygen permeability (cm³/m²-day-atm) was measured under conditions of 30° C. and 70% RH using an oxygen permeability measuring device MOCON (OX-TRAN2/21, made by Modern Controls, Inc.). The results of the measurement of oxygen permeability of the gas barrier films are shown in Table 2.

(Measurement of Water Vapor Permeability)

The water vapor permeability (g/m²-day) was measured under conditions of 40° C. and 90% RH using a water vapor permeability measuring device PERMATRAN W-3/33MG (made by Modern Controls, Inc.). The results of the measurement of water vapor permeability of the gas barrier films are shown in Table 2.

(Measurement of Laminate Strength)

A 30 μm thick unstretched polypropylene film (CPP GLC, manufactured by Mitsui Chemicals Tocello, Inc.) having an ink layer was laminated on the respective gas barrier films of Examples 1 to 9 and Comparative Examples 1 to 5. The unstretched polypropylene film was laminated on a coating side (on a surface to be coated) of the gas barrier films by dry lamination through a polyester polyurethane adhesive (Takelac A-525, manufactured by Mitsui Chemicals, Inc./Takenate A-52, manufactured by Mitsui Chemicals, Inc.) so that the ink layer and the coating side are adjacent to each other, followed by aging at 40° C. for 48 hours to obtain packaging materials. The packaging materials was cut into a 15 mm wide strip, followed by subjecting to 90° peeling at a rate of 300 mm/minute by means of a tensile tester Tensilon to measure laminate strength. The results are shown in Table 2.

(Measurement of Haze)

Examples 1 to 9, the gas barrier films of Comparative Examples 1 to 5 were measured haze (%) using a haze meter (NDH-2000, Nippon Denshoku Industries Co., Ltd.). The results are shown in Table 2.

TABLE 1

| | Water-swelling | | |
|---|---|---|---|
| | Synthetic Micas | | |
| | Solid Content | Mean Area | Thickness of the |
| | Ratios [mass %] | Diameter [μm] | Coating Layer [μm] |
| Example 1 | 20 | 2 | 0.35 |
| Example 2 | 30 | 2 | 0.35 |
| Example 3 | 35 | 2 | 0.35 |
| Example 4 | 50 | 2 | 0.35 |
| Example 5 | 35 | 0.5 | 0.35 |
| Example 6 | 35 | 5 | 0.35 |
| Example 7 | 35 | 2 | 0.1 |
| Example 8 | 35 | 2 | 0.7 |
| Example 9 | 35 | 2 | 1 |
| Comparative | 10 | 2 | 0.35 |
| Example 1 | | | |
| Comparative | 60 | 2 | 0.35 |
| Example 2 | | | |
| Comparative | 35 | 10 | 0.35 |
| Example 3 | | | |
| Comparative | 35 | 2 | 0.01 |
| Example 4 | | | |
| Comparative | 35 | 2 | 0.05 |
| Example 5 | | | |

TABLE 2

| | Oxygen | Water Vapor | | |
|---|---|---|---|---|
| | Permeability | Permeability | Laminate | |
| | [cm³/m² · | [g/m² · | Strength | Haze |
| | day · atm] | day] | [N/15 mm] | [%] |
| Example 1 | 6.245 | 1.949 | 1.6 | 1.7 |
| Example 2 | 2.458 | 1.454 | 1.25 | 1.7 |
| Example 3 | 2.029 | 1.435 | 1 | 1.7 |
| Example 4 | 3.537 | 1.728 | 0.35 | 1.8 |
| Example 5 | 2.205 | 1.436 | 1 | 1.7 |
| Example 6 | 10.2 | 1.56 | 1 | 4.1 |
| Example 7 | 13.116 | 2.201 | 1.3 | 1.7 |
| Example 8 | 0.6 | 1.561 | 0.6 | 2 |
| Example 9 | 0.61 | 1.609 | 0.5 | 2.5 |
| Comparative | 13.652 | 2.152 | 2 | 1.6 |
| Example 1 | | | | |
| Comparative | 5.245 | 1.953 | 0.1 | 2 |
| Example 2 | | | | |
| Comparative | higher than 100 | 3.2 | 1 | 35.8 |
| Example 3 | | | | |
| Comparative | higher than 100 | 3.1 | 1.8 | 1.6 |
| Example 4 | | | | |
| Comparative | 30.6 | 2.397 | 1.3 | 1.5 |
| Example 5 | | | | |

The above results indicate that the gas barrier films in which the solid content ratios and the mean area diameter of the water-swelling mica and the thickness of the coating layer are in specific ranges can be low in oxygen permeability, in water vapor permeability and in haze, and that the gas barrier property and the transparency of the gas barrier film can be improved. In addition, the above results indicate that packaging materials using the gas barrier films in which the solid content ratios and mean area diameter of the water-swelling mica and the thickness of the coating layer are in specific ranges are high in lamination strength, and the cohesive strength of the coating layer of the gas barrier film and the adhesion strength of the coating layer to the substrate can be improved.

(Evaluation of Gas Barrier Properties after Gas Barrier Film is Elongated in MD)

After the gas barrier films according to Examples 1, 3, and 4 are elongated in the MD for a predetermined period of time, the oxygen permeability (equal pressure method) and water vapor permeability are measured in the same way as shown above. The following conditions were used. Table 3 shows the result for the oxygen permeability, and Table 4 shows the result for the water vapor permeability. The “-” in the tables suggests that no measurement was conducted. The relative values of the oxygen permeability and the water vapor permeability in the tables are based on the value of the gas barrier film with MD elongation of 0%.

Size of samples measured: 130 mm wide×260 mm long

Stage interval of the tension testing machine: 200 mm

Tensile strength of pull gauge: 1.2 kg

Tensile speed: 0.1 mm per second

Retention period at elongation rate to evaluate (MD elongation rate): 1 min

TABLE 3

| | | | Example | Example | Example |
|---|---|---|---|---|---|
| | | | 1 | 3 | 4 |
| Solid Content Ratios [mass %] | | | 20 | 35 | 50 |
| Oxygen | MD | 2% | 1.7 | 1.1 | — |
| Permeability | Elongation | 3% | — | 1.8 | — |
| [relative value] | | 5% | 2.1 | 2.4 | 9.2 |
| | | 10% | 9.1 | 2.6 | — |
| | | 20% | — | 26.0 | — |

TABLE 4

| | | | Example | Example | Example |
|---|---|---|---|---|---|
| | | | 1 | 3 | 4 |
| Solid Content Ratios [mass %] | | | 20 | 35 | 50 |
| Water Vapor | MD | 2% | — | 0.83 | — |
| Permeability | Elongation | 5% | 1.26 | 1.13 | 1.16 |
| [relative value] | | | | | |

(Evaluation of Anti-Blocking Agent Contained in Base Material Film)

A test was conducted to evaluate whether the adhesiveness of the base material film and the coating layer show difference depending on the anti-blocking agent contained in the base material film.

### Example 10

A gas barrier film was prepared according to Example 1 except that TSE20M manufactured by Vitopel (anti-blocking agent: PMMA with an average particle diameter of 2.5 μm) was used as a base material film. The results are shown in Table 5. The peal strength of the base material film and the coating layer at 180° was 0.2 N/15 mm.

### Example 11

A gas barrier film was prepared according to Example 1 except that TSE25TA manufactured by Vitopel (anti-blocking agent, synthetic silica with an average particle diameter of 3.0 μm) was used as a base material film. The results are shown in Table 5. The peal strength of the base material film and the coating layer at 180° was 1.7 N/15 mm

TABLE 5

| | Oxygen | Water vapor | |
|---|---|---|---|
| | permeability | permeability | Laminate |
| | [cm³/m² · | [g/m² · | strength |
| | day · atm] | day] | [N/15 mm] |
| Example 10 | 1.6 | 2.4 | 0.3 |
| Example 11 | 4.3 | 2.3 | 1.0 |

### INDUSTRIAL APPLICABILITY

The present invention provides a gas barrier film that has improved gas barrier properties and has both adhesion strength and cohesive strength of a resin film sufficient for use as a packaging material. Also, the present invention provides a packaging material that has improved gas barrier properties and sufficient laminate strength.

### REFERENCE SIGNS LIST

1, 2: Gas barrier film, 10A, 10B, 10C: First film, 11: First base material film, 12: Coating layer, 13, 23: Ink layer, 15: Heat seal layer, 20A, 20B, 20C: second film, 21: Second base material film, 30: Adhesive layer, 50: Base material film, 50s: Heat sealing surface, 50a: First layer, 50b: Second layer, 50c: Skin layer, 100, 200, 300: Packaging material

1. A gas barrier film comprising:
a first base material film made of a plastic material; and
a coating layer formed on one of surfaces of the first base material film,
wherein the coating layer contains a water-soluble polymer and a water-swelling mica,
wherein the solid content ratios of the water-swelling mica in a total solid content of the coating layer are within approximate ranges indicated from 20 mass % to 50 mass %,
wherein the mean area diameter of the water-swelling mica is within approximate ranges indicated from 0.5 μm to 5 μm, and
wherein the thickness of the coating layer is within approximate ranges indicated from 0.1 μm to 1 μm.

2. The gas barrier film of claim 1,
wherein the water-soluble polymer is polyvinyl alcohol resin and
wherein the degree of polymerization of the polyvinyl alcohol resin is within approximate ranges indicated from 1,100 to 2,300.

3. The gas barrier film of claim 1,
wherein the aspect ratio of the water-swelling mica is within approximate ranges indicated from 10 to 200.

4. The gas barrier film of claim 1,
wherein the mean area diameter of the water-swelling mica is within approximate ranges indicated from 1.5 μm to 2.5 μm and
wherein the thickness of the coating layer is within approximate ranges indicated from 0.15 μm to 0.7 μm.

5. The gas barrier film of claim 1, further comprising an ink layer on a surface of the coating layer.

6. The gas barrier film of claim 1, further comprising a heat seal layer or a cold seal layer on a surface of the first base material film.

7. The gas barrier film of claim 1,
wherein the solid content ratios of the water-swelling mica in a total solid content of the coating layer are within approximate ranges indicated from 30 mass % to 40 mass %,

8. The gas barrier film of claim 1,
wherein the first base material film is a biaxially stretched film and the gas barrier film has an oxygen permeability of 10 cm³/m²-day-atm or less after the gas barrier film is elongated by 5% in an MD of the first base material film.

9. The gas barrier film of claim 1,
wherein the first base material film comprises an anti-blocking agent at least at the side of the coating layer, and the anti-blocking agent is an inorganic agent.

10. A packaging material comprising:
a first film;
a second film; and
an adhesive layer formed between the first film and the second film,
wherein the first film comprises a first base material film made of a plastic material and a coating layer formed between the first base material film and the adhesive layer,
wherein the second film comprises a second base material film made of a plastic material,
wherein the coating layer comprises a water-soluble polymer and a water-swelling mica,
the solid content ratios of the water-swelling mica in a total solid content of the coating layer are within approximate ranges indicated from 20 mass % to 50 mass %,
the mean area diameter of the water-swelling mica is within approximate ranges indicated from 0.5 μm to 5 μm, and
the thickness of the coating layer is within approximate ranges indicated from 0.1 μm to 1 μm.

11. The packaging material of claim 10,
wherein the second film comprises an ink layer formed between the second base material film and the adhesive layer.

12. The packaging material of claim 10,
wherein the first film comprises an ink layer formed between the coating layer and the adhesive layer.

13. The packaging material of claim 10,
wherein the first base material film and the second base material film are made of a same plastic material.

14. The packaging material of claim 10,
wherein the water-soluble polymer is polyvinyl alcohol resin and
wherein the degree of polymerization of the polyvinyl alcohol resin is within approximate ranges indicated from 1,100 to 2,300.

15. The packaging material of claim 10,
wherein the aspect ratio of the water-swelling mica is within approximate ranges indicated from 10 to 200.

16. The packaging material of claim 10,
wherein the mean area diameter of the water-swelling mica is within approximate ranges indicated from 1.5 μm to 2.5 μm and
wherein the thickness of the coating layer is within approximate ranges indicated from 0.15 μm to 0.7 μm.
